(19) United States
(12) Patent Application Publication
(10) Pub. No.: US 2007/0235091 A1
(43) Pub. Date: Oct. 11, 2007

(54) Water tap assembly having a pull-out water-discharge head

(76) Inventor: Yoav Granot, Moshav Adanim (IL)

Correspondence Address: Martin D. Moynihan;PRTSI, Inc, P.O. Box 16446, Arlington, VA, 22215, US

(21) Appl. No.: 11/398,628

(22) Filed: Apr. 6, 2006

(51) Int. Cl. F16K 11/20

(52) U.S. Cl. 137/597

(57) ABSTRACT

A water tap assembly particularly for kitchen sinks includes two ports for connection to cold and hot water supply lines, and also a third port for connection to a special-water supply line, e.g., for supplying filtered or carbonated water. The assembly further includes a control valve, a spout, and a water discharge head removably carried by the spout at the end of a pull-out water conduit. The control valve selects whether mixed-water or special-water is fed to the water discharge head, and the latter head includes a diverter which selects whether the mixed-water is to be outletted as an aerated stream or as a spray.

### FIELD AND BACKGROUND OF THE INVENTION

The present invention relates to water tap assemblies having a pull-out water discharge head, and also to water discharge heads particularly useful in such assemblies. The invention is especially useful with respect to the water tap assembly described in my prior U.S. Pat. No. 6,029,699, the contents of which are incorporated herein by reference, and the present invention is therefore described below particularly with respect to that assembly.

My prior U.S. Pat. No. 6,029,699 describes a water tap assembly particularly for kitchen sinks which includes a body member attachable to the kitchen sink and having two ports for connection to cold and hot water supply lines, respectively, plus a third port for connection to a special-water supply line, such as one for supplying filtered water, carbonated water, a beverage, or the like. The water tap assembly further includes a mixing chamber for mixing the water from the cold and hot water supply lines, and a control valve having a manual operator for selectively controlling the water outletted to the spout from a mixed-water outlet and a special-water outlet of the valve. As particularly described in that patent, the manual operator of the control valve selectively controls the water outletted from the mixed-water outlet and special-water outlet such that (a) rotating the handle to a selected position within a first operating region of the control valve connects the hot and cold water supply lines to the mixing chamber and controls the proportion of hot and cold water supplied thereto for discharge from the spout, and (b) rotating the handle to a selected position within a second operating region connects the special-water supply line for discharging only the special-water from the spout.

In one preferred embodiment described in the above patent, the special-water is discharged directly from the spout, whereas the mixed-water is discharged from a head which may be manually removed and used, for example, for rinsing dishes or the like.

However, it has now been found desirable, in many uses of such water tap assemblies, to enable also the special-water to be discharged from the removable head, and/or to enable the removable discharge head to discharge the mixed-water in the form of either an aerated stream or a spray.

### OBJECTS AND BRIEF SUMMARY OF THE PRESENT INVENTION

An object of the present invention is to provide a water tap assembly particularly for kitchen sinks which permits the water discharge head, removable from the spout, to be used not only for rinsing dishes or the like, but also for supplying special-water (e.g. filtered, carbonated, etc. water) from the special-water supply line under the control of the control valve. Another object of the invention is to provide a water discharge head which conveniently permits water to be discharged either as an aerated stream or as a spray.

According to one broad aspect of the present invention, there is provided a water tap assembly particularly for kitchen sinks comprising: a first port for connection to a cold water supply line; a second port for connection to a hot water supply line; a mixing chamber having inlets connected to the first and second ports, and an outlet for outletting mixed-water including the cold and hot water mixed in the mixing chamber; a third port for connection to a special-water supply line; a control valve including inlets connected to the first, second and third ports, the control valve further including a mixed-water outlet, a special-water outlet, and a manual operator for selectively controlling the water outletted from the mixed-water outlet and special-water outlet; and a spout including a water discharge head removably carried by the spout, the spout further including a pull-out water conduit having one end connected to the mixed-water outlet and special-water outlet of the control valve, and an opposite end connected to the water discharge head to discharge therefrom the water from the control valve as selectively controlled by the manual operator.

According to further features in one described preferred embodiment, one end of the pull-out water conduit is connected to the mixed-water outlet and to the special-water outlet of the control valve by a valve connector which includes a housing having an axial inlet extending axially into the housing and communicating with an inner axial passageway therethrough, and a radial inlet extending radially into the housing and communicating with an outer annular passageway extending coaxially with respect to the inner axial passageway.

According to still further features in the described preferred embodiment, the opposite end of the pull-put water conduit is connected to the water discharge head by a connector including a housing constructed so as to be removably attachable to the end of the spout; the housing of the water discharge head connector having an inner axial passageway and an outer annular passageway communicating, via the pull-out water conduit, with the inner axial passageway and outer annular passageway, respectively, of the valve connector.

In the described preferred embodiment, the valve, the connector for the valve, the pull-out water conduit, the connector for the water discharge head, and the water discharge head, are connected together such that the special-water is discharged from the water discharge head as a central stream, and the mixed-water is discharged from the water discharge head as an annular stream.

According to another aspect of the present invention, there is provided a water discharge head comprising a body member including a central discharge outlet for the special-water, an outer annular discharge outlet for the mixed-water, an inner annular discharge outlet also for the mixed-water between the central discharge outlet and the outer annular discharge outlet, and a diverter for selectively diverting the mixed-water to either the outer or the inner annular discharge outlet.

Two embodiments are described for purposes of example. In one described embodiment, the body member is rotatably mounted on a mounting member; and the diverter is effective, upon rotation of the body member to one rotary position with respect to said mounting member, to divert said mixed-water to said outer annular discharge outlet, and upon rotation of the body member to a second rotary position with respect to said mounting member, to divert said mixed-water to said inner annular discharge outlet. In a second described preferred embodiment, the diverter includes a push-button selectively movable to an inner position or to an outer position with respect to said body member to selectively divert said mixed water to either said inner annular discharge outlet or to said outer annular discharge outlet.

As will be described more particularly below, such a water tap assembly conveniently provides either mixed-water (i.e., a mixture of hot/cold water) or a special-water (e.g., carbonated, filtered or other special-water from a special-water supply line) to a remote location under the control of the control valve. When the water tap assembly includes the novel water discharge head, as briefly described above, the assembly conveniently permits the mixed-water to be discharged as either an aerated stream or as a spray. In addition, a water tap assembly including the foregoing features can be constructed from a few relatively simple parts which can be manufactured in volume and at relatively low cost.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates the main elements of one form of water tap assembly constructed in accordance with the present invention;

FIG. 2 is an exploded view of the connector in the water tap assembly of FIG. 1 connecting the control valve to one end of the pull-out water conduit;

FIG. 3 is an end view of the connector of FIG. 2;

FIG. 4 is a section view along line IV-IV of FIG. 3;

FIG. 5 is an exploded view of the connector in the water tap assembly of FIG. 1 connecting the removable water discharge head to the opposite end of the pull-out water conduit;

FIG. 6 is an end view of the connector of FIG. 5;

FIG. 7 is a sectional view along lines VII-VII of FIG. 6;

FIG. 8 is a plan view of a water discharge head constructed in accordance with the present invention which may be used in the water tap assembly of FIG. 1 for selectively discharging the special-water or the mixed-water, and also for selectively producing an aerated-water stream or a spray-water discharge of the mixed-water;

FIG. 9 is a fragmentary view illustrating the condition of the water discharge head of FIG. 8 for producing an aerated-water stream;

FIG. 10 is a corresponding view illustrating the water stream head of FIG. 8 for producing a spray-water discharge;

FIG. 11 is a fragmentary view illustrating the construction of another water discharge head in accordance with the present invention;

FIG. 12 is a fragmentary view, from the opposite side, of the water discharge head of FIG. 11;

FIG. 13 illustrates the diverter in the water discharge head of FIGS. 11 and 12 in the position to produce a spray-water discharge;

FIG. 14 illustrates the diverter of FIGS. 11 and 12 in the position to produce an aerated-water discharge;

FIG. 15 more particularly illustrates the manner in which the diverter of FIGS. 11 and 12 produces a spray discharge when in the position of FIG. 13; and

FIG. 16 more particularly illustrates the manner in which the diverter of FIGS. 11 and 12 produces the aerated-water discharge when in the position of FIG. 14.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiment described is for purposes of example only, and that the invention is capable of being embodied in other forms and applications than described herein.

### DESCRIPTION OF PREFERRED EMBODIMENTS

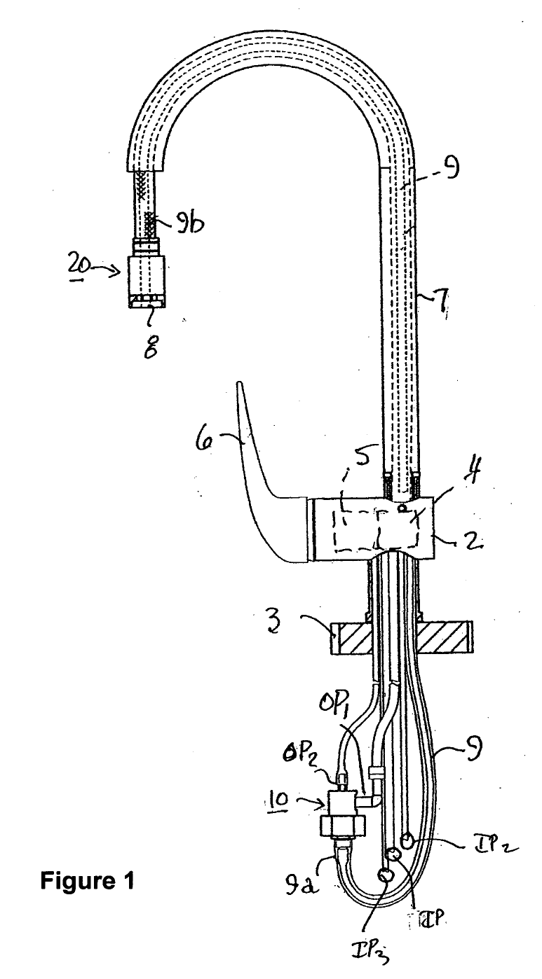

Overall Construction of the Water Tap Assembly of FIGS. 1-7

As indicated earlier, the present invention is particularly useful in the water tap assembly described in my prior U.S. Pat. No. 6,029,699; therefore, FIGS. 1-7 of the accompanying drawings illustrate the invention as implemented in that water tap assembly.

As shown in FIG. 1, the illustrated water tap assembly includes: a body member 2 attachable to the kitchen sink 3; a first inlet port IP₁ connectible to a cold water supply line; a second inlet port IP₂ connectible to the hot water supply line; and a third inlet port IP₃ connectible to a special-water supply line, e.g. supplying filtered water, carbonated water, a beverage, or the like. Body member 2 further includes a mixing chamber, schematically indicated at 4, and a control valve, schematically indicated at 5, controlled by a manual operator, indicated by handle 6. Control valve 5 includes inlets connected to the three inlet ports IP₁, IP₂, and IP₃, and two outlet ports OP₁, OP₂. Manual movement of handle 6 selectively controls the proportions and output rate of the mixed-water from mixing chamber 4 appearing at outlet port OP₁, and also the flow rate of the special-water (e.g., filtered, carbonated, etc.) appearing at the outlet port OP₂.

Control valve 5 is preferably of the construction described in the above-cited U.S. Pat. No. 6,029,699. Further details of its construction and operation are available from that patent therefore, and for the sake of brevity, are not reproduced herein.

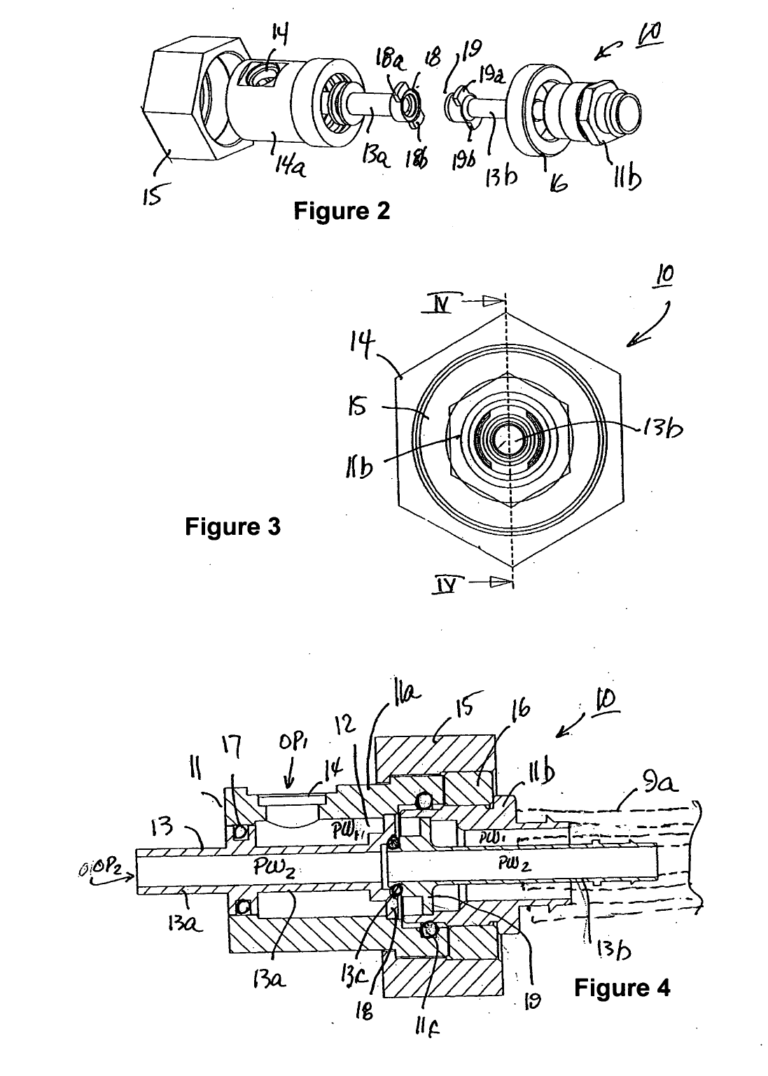

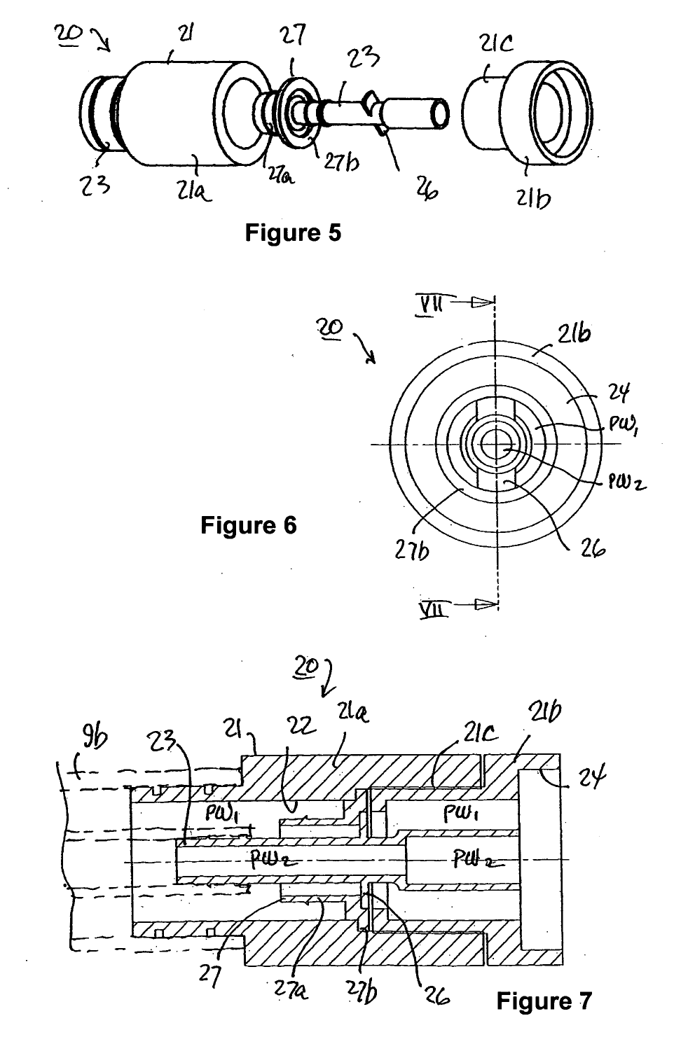

The water tap assembly illustrated in FIG. 1 further includes a spout 7 fixed at one end to body member 2 and detachably carrying at its opposite end a water discharge head 8. Spout 7 encloses a pull-out (sometimes referred to as a “pull-down”) water conduit, indicated by broken lines 9, having one end 9a coupled to the outlet ports OP₁, OP₂ of control valve 5 via a valve connector, generally designated 10 and more particularly illustrated in FIGS. 2-4, and an opposite end 9b coupled to the removable water discharge head 8 by a water discharge head connector, generally designated 20 and more particularly illustrated in FIGS. 5-7.

As will be described below, and as more particularly described in the above-cited U.S. Pat. No. 6,029,699, rotating handle 6 of control valve 5 to a selected position within a first operating region connects the cold and hot inlet water ports IP₁, IP₂, to mixing chamber 4 and controls the proportions of the hot and cold water supplied to the mixing chamber from the respective cold and hot water supply lines for discharge from water discharge head 8; and rotating handle 6 to a selected position within a second operating region connects the special-water supplied via inlet port IP₃ from the special-water supply line (e.g. filtered water, carbonated water, etc.) for discharge from water discharge head 8.

Valve Connector 10

FIGS. 2-4 more particularly illustrate the construction of valve connector 10 connecting the two outlet ports OP₁, OP₂ of control valve 5 to the inlet end 9a of the pull-out water conduit 9, as shown in broken lines in FIG. 4.

Valve connector 10 includes a housing 11 formed with an axial bore 12, and a central tube 13 extending axially through bore 12 of the housing. The diameter of central tube 13 is less than that of bore 12, such that a first passageway PW₁ is defined between the outer surface of tube 13 and the inner surface of housing 11, and a second passageway PW₂ is defined by the inner surface of tube 13. One end of housing 11 is formed with a radially-extending opening 14, for inletting therethrough the water from one of the outlet ports OP₁, OP₂ of control valve 5. The respective end of the central tube 13 is to be connected to the other outlet port of valve 5.

As shown in FIG. 2, and schematically indicated in FIG. 4, the left end of central tube 13 is connected to the special-water outlet port OP₂ of the control valve 5, so as to conduct the special-water through connector 10 via the inner axial passageway PW₂; whereas the side inlet 14 into housing 10 is connected to outlet OP₁ of valve 5 so as to conduct the mixed-water therefrom through the outer annular passageway PW₁, coaxial with inner axial passageway PW₂, through connector 10.

As shown in particularly in FIGS. 2 and 4, housing 11 is constituted of two sections 11a, 11b joined together by a collar 15 and a nut 16 into which housing section 11b is threaded. The two housing sections are sealed with respect to each other by an annular seal 11c received between the inner surface of housing section 11a and the outer surface of housing section 11b.

Similarly, central tube 13 is constituted of two sections 13a, 13b in axial alignment with each other and sealed with respect to each other by an annular sealing ring 13c interposed between the two tube sections. The inlet end of the central tube 13 is sealed by an annular sealing ring 17 received within a recess in an annular wall 17a formed integrally with tube section 13a, so as to define one end of the outer annular passageway PW₁ for the mixed-water supplied via outlet OP₁ of the control valve. In addition, each of the two tube sections 13a, 13b, is formed with a spider 18, 19, each including a pair of radially-extending spider arms 18a, 18b and 19a, 19b, respectively, engageable with the inner surfaces of bore 12 extending through the two housing sections 11a, 11b, respectively. The construction is such that the spaces between the spider arms maintain continuity in the outer annular passageway PW₁ for the mixed-water from radial inlet opening 14 to the outlet end of valve connector 10 connected to end 9a of the pull-out water conduit 9, as shown in broken lines in FIG. 4.

In the embodiment illustrated in FIGS. 2-4, each of the two spider arms 18a, 18b includes but two radially-extending arms defining the spaces to produce continuity in the flow of the water via annular passageway PW₁. In larger constructions, each spider may include three (or more) such radially-extending arms.

It will thus be seen that connector assembly 10 illustrated in FIGS. 2-4 is effective to conduct the water from the special-water supply line ouputted at outlet port OP₂ of FIG. 1 via the inner axial passageway PW₂, and to conduct the mixed-water appearing at outlet port OP₁ of control valve 2 via the outer annular passageway PW₁ coaxial with respect to the inner axial passageway PW₂.

Water-Discharge Head Connector 20

FIGS. 5-7 illustrate the structure of connector 20 which, as shown in FIG. 1, connects the outlet end 9b of the pull-out water conduit 9 to water discharge head 8 removably attached to the end of spout 7.

Connector 20 includes a housing 21, also constituted of two sections 21a, 21b, formed with a bore 22 receiving a central tube 23 of smaller outer-diameter than that of bore 22 so as to define an outer annular passageway PW₁ for the mixed-water fed via the outer annular passageway PW₁ through connector 10 at the inlet end 9a of the pull-out water conduit 9. The inner surface of central tube 23 defines an inner, central, axial passageway PW₂ for the special-water (e.g. filtered, carbonated, etc.) supplied via the valve outlet port OP₂ and fed via PW₂ of connector 10 at the inlet end 9a of the water pull-out conduit 9.

The two housing sections 21a, 21b of connector 20 are secured together by threads 21c. The outer surface of housing 21a is dimensioned so as to be releasably (e.g., frictionally) received within the outer end of spout 5. The inner surface of housing section 21b is formed with a cylindrical recess 24 for receiving (e.g., by a frictional fit) the water discharge head 8.

Continuity between the two housing sections 21a, 21b in the outer annular passageway PW₁ is established by a spider 25 integrally formed on the outer surface of the central tube 23. As in connector 10 illustrated in FIGS. 2-4, spider 25 includes a pair of radially-extending arms 25a, 25b, to define spaces between them for establishing communication between the two parts of the outer annular passageway PW₁ defined by the two housing sections 21a, 21b.

The illustrated water tap assembly further includes a collar 26 interposed between central tube 23 and the two housing sections 21a, 21b. Collar 27 includes a tubular section 26a of larger diameter than center tube 23, and an enlarged-diameter flange section 26b at the opposite end for engagement with spider 25 and for clamping the spider arms between the two housing sections 21a, 21b when secured together by thread 21c. As indicated above, the spaces between the two radial arms of spider 25 thus establish communication between the two parts of annular passageway PW₁ defined by the two housing sections 21a, 21b.

Overall Operation

The overall operation of the water tap assembly illustrated in FIGS. 1-7 of the drawings will be apparent from the above description.

Thus, as described above, handle 6 of valve 5 may be used for controlling the mixed-water supplied via outlet port OP₁ to the valve connector 10, and also the special (e.g., filtered, carbonated) water supplied via outlet port OP₂ of the connector. The special-water at outlet port OP₂ is fed via the inner axial passageway PW₂ of connector 10 at the inlet end 9a of the pull-out water conduit 9, and also via the inner axial passageway PW₂ of connector 20 at the outlet end 9b of the pull-out water conduit. On the other hand, the mixed-water at outlet port OP₁ is introduced via the radial inlet 14 in connector 10, flows via the outer annular passageway PW₁, coaxial to the axial passageway PW₂, through connector 10, into the inlet end 9a of pull-out water conduit 9, via the outer annular passageway PW₁ in connector 20 at the outlet end 9b of the pull-out water conduit, to the water discharge head 8 secured within recess 24 of connector 20.

Thus, the special-water, e.g., filtered or carbonated water, will be discharged from head 8 in the form of an axial stream centrally of the head, and the mixed hot/cold water will be discharged from head 8 as an outer annular stream around, and coaxially with respect to, the axial stream of the special-water. Preferably, water discharge head 8 includes an aerator, of known construction, for aerating the mixed-water discharged via the outer annular passageway.

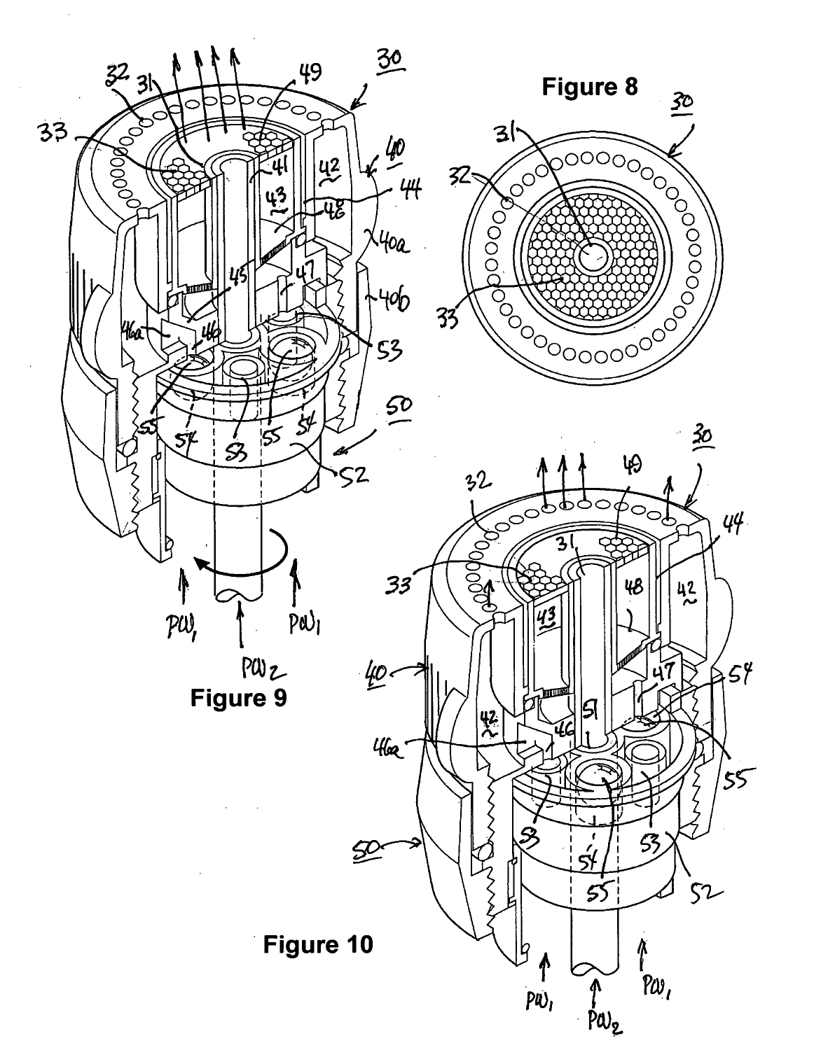

Water-Discharge Head of FIGS. 8-10

FIGS. 8-10 illustrate a water discharge head construction which conveniently permits the mixed-water to be discharged as either an aerated stream, or as a spray. Such a water discharge head is particularly useful in the above-described water tap assembly to enable the user to conveniently select (1) a special-water discharge, (2) a mixed-water discharge in the form of an aerated stream, or (3) a mixed-water discharge in the form of a spray.

The water discharge head illustrated in FIGS. 8-10 is generally designated 30. It includes a central water discharge outlet 31 for the special-water (e.g., filtered or carbonated) water, an outer discharge outlet 32 in the form of an annular array of small-diameter openings for producing a spray discharge of the mixed-water, and another discharge outlet 33, between outlets 31 and 32, for discharging the mixed-water in the form of an aerated stream.

As will also be described below, the water discharge head 30 includes a diverter for selectively diverting the mixed-water to either outlets 32 or 33 to produce either a spray-water discharge via openings 32, or an aerated-water stream via outlet 33.

As shown in FIGS. 9 and 10. water discharge head 30 includes a body member 40, constructed of two threaded sections 40a, 40b, rotatably mounted on a mounting member 50 so as to be rotatable to either the rotatable position illustrated in FIG. 9 for producing an aerated-water stream via outlet 33, or to the rotatable position illustrated in FIG. 10 for producing a spray-water stream via outlet openings 32. It will be appreciated that when the water discharge head 30 illustrated in FIGS. 8-10 is used with the water tap assembly described above with respect to FIGS. 1-7, handle 6 (FIG. 1) of the water tap assembly would be selectively positioned to select either a special-water discharge via passageway PW₂ (FIG. 7), or a mixed-water discharge via passageway PW₁; whereas body member 40 would be selectively rotated for diverting the mixed-water either through the openings of the spray-water outlet 32, or through the aerated-water outlet 33.

Rotatable body member 40, carrying the three types of water discharge outlets 31, 32, 33, respectively, includes a central tube 41. In both rotatable positions of body member 40 shown in FIGS. 9 and 10, respectively, central tube 41 in body member 40 remains in alignment with a central tube 51 in mounting member 50, which defines the central passageway PW₂ of the special-water that may be selectively discharged by the water tap assembly.

Body member 40 further includes two annular chambers 42, 43, communicating with the water discharge outlets 32, 33, respectively. The two annular chambers 42, 43 are defined by a cylindrical partition 44 coaxial with central tube 41, and an end wall 45 closing the inner end of cylindrical partition 44 but formed with a central opening for accommodating central tube 41. The outer diameter of end wall 45 is formed with a plurality of bores 46 (only one being seen in FIGS. 9 and 10) having radial slots 46a serving as one group of passageways communicating with the outer annular passageway 42. End wall partition 45 is further formed with a plurality of bores 47 serving as a second group of passageways communicating with the inner annular passageway 43 in body member 40.

Body member 40 further includes an aerator disc 48 within its inner annular passageway 43, and an aerator screen 49 at the outlet end of passageway 43. Aerator disc 48 is formed with a plurality of perforations in order to produce a turbulent flow of the mixed-water entering that annular passageway via the mixed-water passageway PW₁, and aerator screen 49 serves to further aerate the water before it is discharged as an aerated stream via outlet 33.

Mounting member 50 of the water discharge head 30 illustrated in FIGS. 8-10 includes a central tube 51 defining the central passageway PW₂ for the special-water selectively outletted from the water tap assembly. As indicated above, central tube 51 of mounting member 50 is aligned, and remains aligned, with central tube 31 of body member 40 in both rotatable positions of the body member.

Body member 50 further includes an end wall 52 which closes the outer annular passageway PW₁ for the mixed-water from the water tap assembly. End wall 52 is formed with a group of bores 53 therethrough both communicating with the mixed-water annular passageway PW₁ enclosing central tube 51 defining the central special-water passageway PW₂. The through-going bores 53 are spaced about the circumference of end wall 52 so as to be selectively alignable with bores 46 in body member 40 in one rotary position of the body member, and with bores 47 in the other rotary position of the body member.

It will thus be seen that when body member 40 is in one rotary position such that bores 46 are in alignment with bores 53 of mounting member 50, the mixed-water from passageway PW₁ is diverted via bores 46, slot extensions 46a, and the outer annular passageway 42, to the outer array of small-diameter openings of outlet 32 such that the water is discharged from the head in the form of an annular spray; whereas when body member 40 is rotated to a second position, wherein its bores 47 are aligned with bores 53 in body member 50, the mixed-water from passageway PW₁ is directed via the inner annular passageway 43, aerator disc 48, and aerator screen 49, to outlet 33 and discharged in the form of an aerated stream.

End wall 52 is further formed with a plurality of blind bores 54 between the through-going bores 53. Each blind bore 54 seats a ball 55, which balls are alignable with one group of bores (46 or 47) of the body member 40 in one rotary position of the body member for blocking flow through the respective group of bores, while a flow is produced through the other group of bores in the body member. Thus, FIG. 9 illustrates the position of body member 40 wherein a through-going bore 53 of mounting 50 member is aligned with a bore 47 of the body member to produce a flow through the inner annular passageway 43 and an aerated stream via outlet 33, whereas balls 55 of the mounting member are aligned with bores 46 to block the flow through the outer annular passageway 42 and out through the spray openings 32. FIG. 10 illustrates the second position of body member 40 wherein the mixed-water is diverted to the outer annular passageway 42 and through the outer spray openings 32, whereas the balls 55 of mounting member 50 block the flow to the inner annular passageway 43 and out through discharge outlet 33.

It will be appreciated that, when the water discharge head 30 illustrated in FIGS. 8-10 is used with the water tap assembly of FIGS. 1-7, handle 6 may be used for selectively producing a special-water discharge via passageway PW₂ and through the central discharge outlet 31 of the water discharge head 30, or to produce a mixed-water outlet into passageway PW₁; whereas body member 40 of the water discharge head 30 may be used for selectively diverting the mixed-water from passageway PW₁ either to the inner passageway 43 for producing an aerated-water stream via outlet openings 33, or to the outer annular passageway 42 for producing a spray-water discharge via outlet openings 32.

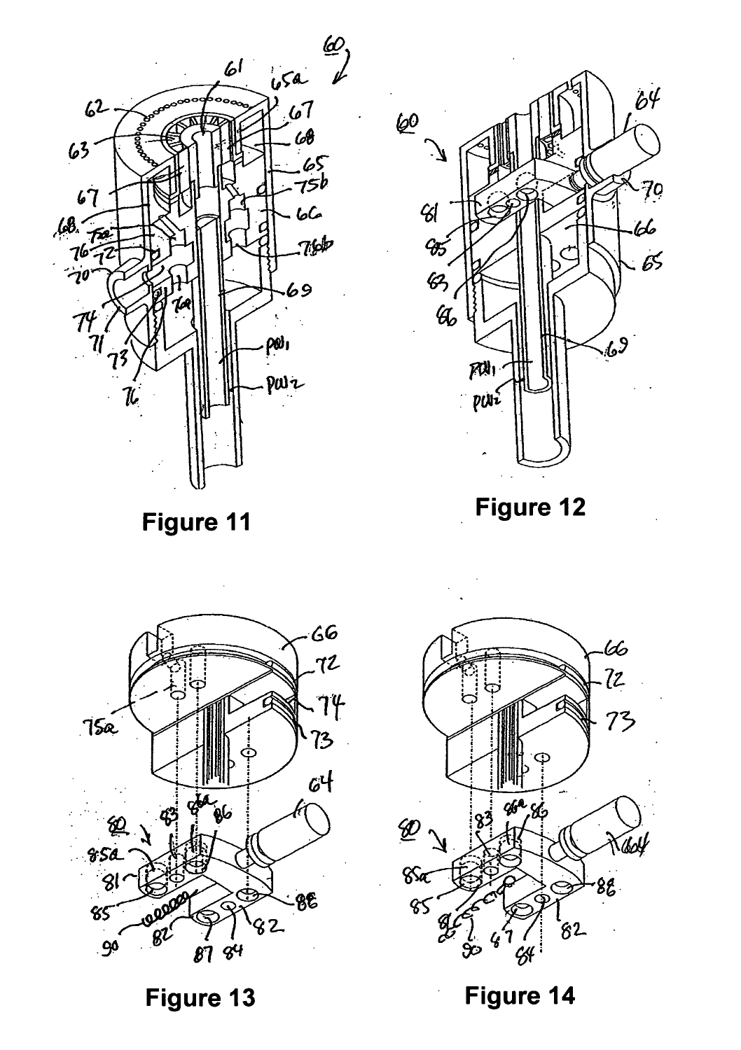

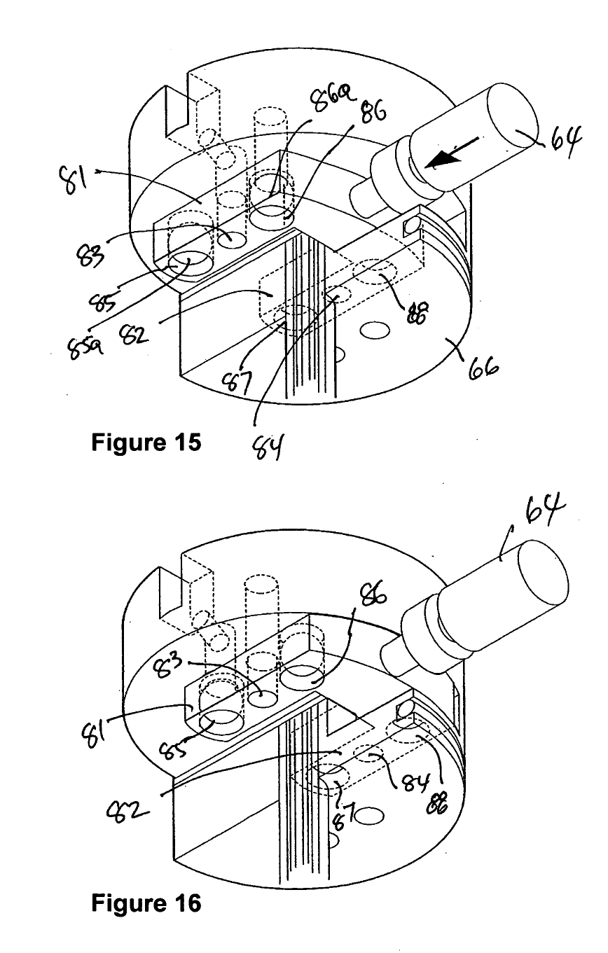

Water-Discharge Head of FIGS. 11-16

FIGS. 11-16 illustrate another construction of water discharge head for producing either a spray-water discharge or an aerated-water discharge.

As shown particularly in FIGS. 11 and 12, the illustrated water discharge head, therein generally designated 60, includes a central water discharge outlet 61 for the special-water (e.g., filtered or carbonated water), an outer discharge outlet 62 in the form of an annular array of small-diameter openings for producing a spray discharge of the mixed-water, and another discharge outlet 63, between outlets 61 and 62, for discharging the mixed-water in the form of an aerated stream. As will be described more particularly below, the water-discharge head further includes a push-button 64 manually movable to selectively divert the mixed-water inletted into the discharge head via passageway PW₂, to either the aerated-water discharge outlet 63 or the spray-water discharge outlet 62. In either position of push-button 64, the special-water inletted via passageway PW₁ is discharged via the central water discharge outlet 61.

As seen particularly in FIGS. 11 and 12, water discharge head 60 includes a body member 65 of cylindrical configuration, and a partition 66 extending transversely across the body member. The top wall of body member 65 further includes a cylindrical re-entry wall 65a, which divides the upper interior of the body member into an inner annular passageway 67 communicating with the aerated-water discharge outlet 63, and an outer annular passageway 68 communicating with the spray-water discharge outlet 62. Body member 65 further includes a central tube 69 communicating with the special-water central passageway 61 in both positions of the push-button 64.

Body member 65 is integrally formed with a side protrusion 70 defining an opening 71 for receiving push-button 64, and for guiding its movements within the body member. Partition 66 includes a pair of seals 72, 73 on opposite sides of its opening 71 to thereby seal the interior of body member 65 with respect to that opening.

Partition 66 is formed with a diametrically-extending slot 74 aligned with opening 71 receiving push-button 64 so as to define two partition sections 75, 76, spaced by slot 74. Partition section 75 includes a bore 75a on one side of its center line communicating with the outer annular passageway 68, and another bore 75b on the opposite side of its center communicating with the inner annular passageway 67. Partition section 76 includes two similar bores 76a, 76b, aligned with bore 75a, 75b of partition section 75.

Push-button 64 is fixed to a valve member, generally designated 80, movable within slot 74 of partition 66. Valve member 80 includes two legs 81, 82 disposed within slot 74 on opposite sides of the center tube 69. Bridging section of valve member 80 is fixed to push-button 64 such that two legs 81, 82 of valve member 80 are movable to inner and outer positions by the push-button 64.

Each of the legs 81, 82 of valve member 80 includes a bore 83, 84, selectively alignable with one of the bores 75a, 75b and 76a, 76b of partition sections 75 and 76 according to the position of push-button 64. In addition, each of the valve legs 81, 82 includes a pair of bores 85, 86 and 87, 88, respectively, on the opposite sides of its respective bores 83, 84. Each of the bores 85-88 holds a ball, (e.g. 85a, 86a) such that when bore 83, 84 of valve member 80 is in alignment with one of the bores 75a, 75b and 76a, 76b of the partition sections 75 and 76, respectively, the other bores of the partition sections are blocked by the balls in bores 85-88 of the valve member.

The illustrated water-discharge head preferably also includes a spring, schematically indicated at 90 in FIGS. 13 and 14, urging push-button 64 to its outermost position.

The operation of water-discharge head 60 illustrated in FIGS. 11-16 will be apparent from the above description.

Thus, spring 90 normally urges push-button 64 to its outermost position, wherein bores 83 and 84 of valve member 80 are aligned with bores 75b, 76b of partition 66, such that the mixed water flowing via passageway PW₂ is directed into the inner annular chamber 67 to produce an aerated-water discharge from discharge openings 63. In this normal condition of the push-button, the balls within bores 85 and 87 of valve member 80 are in alignment with bores 75a, 76a of partition 66, so as to block the flow of the mixed-water via the outer annular chamber 68 to the spray openings 62 of the water discharge head.

When it is desired to produce a spray-water discharge, push-button 64 is depressed inwardly, whereupon bores 83, 84 of valve member 80 become aligned with bores 75a, 76a of partition member 66. This diverts the mixed-water in passageway Pw₂ to the outer annular passageway 68 and to the spray-discharge openings 62. At the same time, the balls (e.g. 86a) within bores 86, 88 of valve member 80 become aligned with bores 75b, 76b of partition 66, thereby blocking the flow of the mixed water to the inner annular passageway 67 and to the aerated-water discharge openings 63.

+6While the invention has been described with respect to preferred embodiments, it will be appreciated that these are set forth merely for purposes for example, and that many other variations, modifications and applications of the invention may be made.

What is claimed is:

1. A water tap assembly particularly for kitchen sinks, comprising:
a first port for connection to a cold water supply line;
a second port for connection to a hot water supply line;
a mixing chamber having inlets connected to said first and second ports, and an outlet for outletting mixed-water including the cold and hot water mixed in said mixing chamber;
a third port for connection to a special-water supply line;
a control valve including inlets connected to said first, second and third ports, said control valve further including a mixed-water outlet, a special-water outlet, and a manual operator for selectively controlling the water outletted from said mixed-water outlet and special-water outlet; and
a spout including a water discharge head removably carried by said spout, said spout further including a pull-out water conduit having one end connected to said mixed-water outlet and special-water outlet of the control valve, and an opposite end connected to said water discharge head to discharge therefrom the water from said control valve as selectively controlled by said manual operator.

2. The water tap assembly according to claim 1, wherein said one end of the pull-out water conduit is connected to said mixed-water outlet and to said special-water outlet of the control valve by a valve connector which includes a housing having an axial inlet extending axially into the housing and communicating with an inner axial passageway therethrough, and a radial inlet extending radially into the housing and communicating with an outer annular passageway extending coaxially with respect to said inner axial passageway.

3. The water tap assembly according to claim 2, wherein said axial inlet in the connector housing is connected to said special-water outlet of the control valve, and said radial inlet in the connector housing is connected to said mixed-water outlet of the control valve.

4. The water tap assembly according to claim 2, wherein said valve connector further includes a tube within said housing and defining said inner axial passageway therethrough;
the outer surface of said tube being formed at one end with an annular wall sealingingly engageable with an inner surface of said housing to define therebetween the inlet end of said outer annular passageway;
said radial inlet being formed in said housing to communicate with said outer annular passageway.

5. The water tap assembly according to claim 4, wherein said tube includes first and second tube sections secured together in axial alignment with each other to define said inner axial passageway through the housing; said first tube sections including said annular wall sealingly engageable with the inner surface of said housing to define the inlet end of said outer annular passageway.

6. The water tap assembly according to claim 5, wherein the end of said first tube section opposite to that formed with said annular wall is formed with a plurality of circumferentially-spaced spider arms engageable with the inner surface of said housing to permit water flow between said spider arms from said inlet end to the outlet end of said outer annular passageway.

7. The water tap assembly according to claim 6, wherein said second tube section is also formed with a plurality of circumferentially-spaced spider arms engageable with the inner surface of said housing to permit water flow between said spider arms from said inlet end to said outlet end of said outer annular passageway.

8. The water tap assembly according to claim 7, wherein said tube further includes an annular seal between said first and second tube sections.

9. The water tap assembly according to claim 2, wherein said housing includes two housing sections secured together in axial alignment, and a sealing ring between the two housing sections.

10. The water tap assembly according to claim 2, wherein said opposite end of the pull-put water conduit is connected to said water discharge head by a connector including a housing constructed so as to be removably attachable to the end of said spout; said housing of the water discharge head connector having an inner axial passageway and an outer annular passageway communicating, via said pull-out water conduit, with said inner axial passageway and outer annular passageway, respectively, of said valve connector.

11. The water tap assembly according to claim 10, wherein said housing of the water discharge head connector includes a central tube formed with said inner axial passageway, and two housing sections secured together in axial alignment with each other and with said center tube passing axially therethrough; said two housing sections being configured to define said outer annular passageway between the outer surface of said central tube and the inner surface of said two housing sections.

12. The water tap assembly according to claim 11, wherein said central tube further includes a plurality of radially-extending spider arms clamped between said two housing sections and dividing said outer annular passageway into two sections communicating with each other via the spaces between said spider arms.

13. The water tap assembly according to claim 12, wherein said housing of the water discharge head further includes an annular collar interposed between said two housing sections and coaxially-spaced from the inlet end of said central tube; said annular collar bearing against said spider arms for clamping said central tube between said housing sections.

14. The water tap assembly according to claim 1, wherein: said valve, said connector for said valve, said pull-out water conduit, said connector for said water discharge head, and said water discharge head, are connected together such that the special-water is discharged from said water discharge head as a central stream, and said mixed-water is discharged from said water discharge head as an annular stream.

15. The water tap assembly according to claim 14, wherein said water discharge head comprises:
a body member including a central discharge outlet for said special-water;
an outer annular discharge outlet for said mixed-water;
an inner annular discharge outlet also for said mixed-water between said central discharge outlet and said outer annular discharge outlet;
one of said discharge outlets producing a stream discharge, and the other of said discharge outlets producing a spray discharge; and
a diverter for selectively diverting said mixed-water to either said outer or said inner annular discharge outlet.

16. The water tap assembly according to claim 15, wherein said body member is rotatably mounted on a mounting member; and wherein said diverter is effective, upon rotation of the body member to one rotary position with respect to said mounting member, to divert said mixed-water to said outer annular discharge outlet, and upon rotation of the body member to a second rotary position with respect to said mounting member, to divert said mixed-water to said inner annular discharge outlet.

17. The water tap assembly according to claim 16, wherein said body member and said mounting member include central passageways for the special-water, which central passageways are aligned, and remain aligned with respect to each other in both rotational positions of the body member.

18. The water tap assembly according to claim 17, wherein said diverter comprises:
a plurality of bores through said mounting member communicating with an annular passageway enclosing said central passageway of the mounting member;
a first bore in said body member communicating with said outer annular discharge outlet and alignable with a bore of said mounting member in said one rotary position of the body member with respect to the mounting member;
and a second bore in said body member communicating with said inner annular discharge outlet and alignable with another bore of said mounting member in said second rotary position of the body member with respect to the mounting member.

19. The water tap assembly according to claim 18, wherein said mounting member further comprises:
a first ball alignable with said second bore of the body member in said first rotary position of the body member for blocking flow through said second bore of the body member; and
a second ball alignable with said first bore of the body in said second rotary position of the body member for blocking flow through said first bore of the body member.

20. The water tap assembly according to claim 16, wherein said inner annular discharge outlet includes an aerator screen for producing an aerated-discharge therefrom, and said second outer annular discharge outlet includes a plurality of relatively small discharge openings for producing a spray-water discharge therefrom.

21. The water tap assembly according to claim 15, wherein said diverter includes a push-button selectively movable to an inner position or to an outer position with respect to said body member to selectively divert said mixed water to either said inner annular discharge outlet or to said outer annular discharge outlet.

22. The water tap assembly according to claim 21,
wherein said water discharge head further includes a partition extending transversely across said body member and formed with a central passageway for the special-water, a first bore communicating with said outer annular discharge outlet, and a second bore communicating with said inner annular discharge outlet; and
wherein said diverter includes a valve member coupled to said push-button so as to be moved therewith, said valve member including a bore selectively alignable with said first and second bores of the partition according to the position of the push-button.

23. The water tap assembly according to claim 22, wherein said valve member further includes a pair of balls located on opposite sides of said bore of the valve member such that when said bore of the valve member is aligned with one of said bores of the partition to permit flow therethrough, one of said balls of the valve member is aligned with the other of said bores of the partition to block flow therethrough.

24. The water assembly according to claim 23, wherein said partition includes two of said first bores on opposite sides of said central passageway communicating with said annular discharge outlet, and two of said second bores on opposite sides of said central passageway communicating with said inner annular discharge outlet; and
wherein said valve member includes two legs straddling said central passageway, each of said legs including a bore selectively alignable with said first and second bores of the partition according to the position of the push-button, and a pair of said balls located on opposite sides of the bore in the respective leg.

25. A water tap assembly particularly for kitchen sinks, comprising:
a first port for connection to a cold water supply line;
a second port for connection to a hot water supply line;
a mixing chamber having inlets connected to said first and second ports, and an outlet for outletting the cold and hot water mixed in said mixing chamber;
a third port for connection to a special-water supply line;
a control valve including inlets connected to said first, second and third ports, said control valve further including a mixed-water outlet, a special-water outlet, and a manual operator for selectively controlling the water outletted from said mixed-water outlet and special-water outlet; and
a spout including a water discharge head removably carried by said spout, said spout further including a pull-out water conduit having one end connected to said mixed-water outlet and special-water outlet of the control valve, and an opposite end connected to said water discharge head to discharge therefrom the water from said control valve as selectively controlled by said manual operator;
said valve, connector for said valve, pull-out water conduit, connector for said water discharge head, and water discharge head, all being connected together such that the special-water is discharged from said water discharge head as a central stream, and said mixed-water is discharged from said water discharge head as an annular stream.

26. The water tap assembly according to claim 25, wherein said one end of the pull-out water conduit is connected to said mixed-water outlet and to said special-water outlet of the control valve by a valve connector which includes a housing having an inlet extending axially into the housing and communicating with an inner axial passageway therethrough, and a radial inlet extending radially into the housing and communicating with an outer annular passageway extending coaxially to said inner axial passageway.

27. The water tap assembly according to claim 26, wherein said valve connector further includes a tube within said housing and defining said inner axial passageway therethrough;
the outer surface of said tube being formed at one end with an annular wall sealingingly engageable with an inner surface of said housing to define therebetween the inlet end of said outer annular passageway;
said radial inlet being formed in said housing to communicate with said outer annular passageway.

28. The water tap assembly according to claim 25, wherein said housing includes two housing sections secured together in axial alignment, and a sealing ring between the two housing sections.

29. The water tap assembly according to claim 25, wherein said opposite end of the pull-put water conduit is constructed to said water discharge head by a connector including a housing constructed so as to be removably attachable to the end of said spout.

30. A water discharge head for a water tap assembly capable of selectively outletting either mixed-water from a mixing chamber in which hot and cold water are mixed, or special-water from a special-water supply line, said water discharge head comprising:
a body member including a central discharge outlet for said special-water;
an outer annular discharge outlet for said mixed-water;
an inner annular discharge outlet also for said mixed-water between said central discharge outlet and said outer annular discharge outlet;
one of said discharge outlets producing a stream discharge, and the other of said discharge outlets producing a spray discharge;
and a diverter for selectively diverting said mixed-water to either said outer or said inner annular discharge outlet.

31. The water discharge head according to claim 30, wherein said body member is rotatably mounted on a mounting member; and wherein said diverter is effective, upon rotation of the body member into one rotary position with respect to said mounting member, to divert said mixed-water to said outer annular discharge outlet, and upon rotation of the body member to a second rotary position with respect to said mounting member, to divert said mixed-water to said inner annular discharge outlet.

32. The water discharge head according to claim 31, wherein said body member and said mounting member include central passageways for the special-water, which central passageways are aligned, and remain aligned with respect to each other in both rotational positions of the body member.

33. The water discharge head according to claim 32, wherein said diverter comprises:
a plurality of bores through said mounting member communicating with an annular passageway enclosing said central passageway of the mounting member;
a first bore in said body member communicating with said outer annular discharge outlet and alignable with a bore of said mounting member in said one rotary position of the body member with respect to the mounting member; and
a second bore in said body member communicating with said inner annular discharge outlet and alignable with another bore of said mounting member in said second rotary position of the body member with respect to the mounting member.

34. The water discharge head according to claim 33, wherein said mounting member further comprises:
a first ball alignable with said second bore of the body member in said first rotary position of the body member for blocking flow through said second bore of the body member; and
a second ball alignable with said first bore of the body in said second rotary position of the body member for blocking flow through said first bore of the body member.

35. The water discharge head according to claim 30, wherein said inner annular discharge outlet includes an aerator screen for producing an aerated-discharge therefrom, and said outer annular discharge outlet includes a plurality of relatively small discharge openings for producing a spray-water discharge therefrom.

36. The water discharge head according to claim 30, wherein said diverter includes a push-button selectively movable to an inner position or to an outer position with respect to said body member to selectively divert said mixed water to either said inner annular discharge outlet or to said outer annular discharge outlet.

37. The water discharge head according to claim 36:
wherein said water discharge head further includes a partition extending transversely across said body member and formed with a central passageway for the special-water, a first bore communicating with said outer annular discharge outlet, and a second bore communicating with said inner annular discharge outlet; and
wherein said diverter includes a valve member coupled to said push-button so as to be moved therewith, said valve member including a bore selectively alignable with said first and second bores of the partition according to the position of the push-button.

38. The water discharge head according to claim 37, wherein said valve member further includes a pair of balls located on opposite sides of said bore of the valve member such that when said bore of the valve member is aligned with one of said bores of the partition to permit flow therethrough, one of said balls of the valve member is aligned with the other of said bores of the partition to block flow therethrough.

39. The water discharge head according to claim 38, wherein said partition includes two of said first bores on opposite sides of said central passageway communicating with said annular discharge outlet, and two of said second bores on opposite sides of said central passageway communicating with said inner annular discharge outlet; and
wherein said valve member includes two legs straddling said central passageway, each of said legs including a bore selectively alignable with said first and second bores of the partition according to the position of the push-button, and a pair of said balls located on opposite sides of the bore in the respective leg.
